(19) United States
(12) Patent Application Publication
(10) Pub. No.: US 2013/0285467 A1
(43) Pub. Date: Oct. 31, 2013

(54) POWER TRANSMISSION SYSTEM

(71) Applicant: MURATA MANUFACTURING CO., LTD., Nagaokakyo-Shi (JP)

(72) Inventor: HIRONOBU TAKAHASHI, Nagaokakyo-Shi (JP)

(21) Appl. No.: 13/933,408

(22) Filed: Jul. 2, 2013

Related U.S. Application Data
(63) Continuation of application No. PCT/JP2012/076582, filed on Oct. 15, 2012.

(30) Foreign Application Priority Data
Feb. 24, 2012 (JP) 2012-038127

(51) Int. Cl. H01F 38/14

(52) U.S. Cl. CPC H01F 38/14
USPC 307/104

(57) ABSTRACT

A power transmission system capable of detecting a point of maximum impedance even when the resonant frequency is a comparatively high frequency and the frequency is swept in a range including a frequency at which the impedance is maximum.

The power transmission system includes a power transmission device having a pair of first electrodes and a signal source, and a power reception device having a pair of second electrodes arranged to respectively oppose the first electrodes and are capacitively coupled with the first electrodes, and a load circuit. The power transmission system includes first and second resonant circuits and transmits power at a driving frequency determined by sweeping the frequency of an alternating current signal. The frequency is swept in a preset range and the driving frequency is set to the frequency at which the impedance is maximum measured in the sweeping of the frequency.

### CROSS REFERENCE TO RELATED APPLICATIONS

The present application is a continuation of PCT/JP2012/076582 filed Oct. 15, 2012, which claims priority to Japanese Patent Application No. 2012-038127, filed Feb. 24, 2012, the entire contents of each of which are incorporated herein by reference.

### FIELD OF THE INVENTION

The present invention relates to power transmission systems in which power is transmitted without physical contact.

### BACKGROUND OF THE INVENTION

In recent years, numerous electronic appliances that transmit power in a non-contact manner have been developed. In order to transmit power to an electronic appliance in a non-contact manner, a power transmission system is often adopted that employs a magnetic coupling scheme in which coil modules are included in both a power transmission unit and power reception unit.

However, in such magnetic-coupling-scheme power transmission systems, the amount of magnetic flux passing through each coil module is greatly affected by the electromotive force and, in order to transmit power with high efficiency, high accuracy is needed in the control of the relative positions in plan view of the coil module of the power transmission unit side (primary side) and the coil module of the power reception unit side (secondary side). In addition, since coil modules are used as coupling electrodes, it is difficult to reduce the size of the power transmission unit and the power reception unit. In addition, in electronic appliances such as portable appliances, there have also been issues in that it has been necessary to consider the effect that heat generated by a coil will have on a battery and there is a risk that will be a bottleneck in layout design.

Accordingly, for example, power transmission systems have been developed that employ an electrostatic field. In Patent Document 1, a power transmission system is disclosed in which high power transmission efficiency is realized by capacitively coupling a coupling electrode on a power transmission unit side and a coupling electrode on a power reception unit side.

FIG. 9 is a schematic diagram that illustrates the configuration of a power transmission system of the related art. FIG. 9(a) is a schematic diagram illustrating the configuration of a power transmission system that employs asymmetrical capacitive coupling. As illustrated in FIG. 9(a), a power transmission unit (power transmission device) 1 side is provided with a large passive electrode 3, a small active electrode 4 and a power supply circuit (power supply) 100, and a power reception unit (power reception device) 2 side is provided with a large passive electrode 5, a small active electrode 6 and a load circuit 24. A strong electric field 7 is formed between the active electrode 4 on the power transmission unit 1 side and the active electrode 6 on the power reception unit 2 side, whereby high power transmission efficiency is realized.

In addition, FIG. 9(b) is a schematic diagram illustrating the configuration of a power transmission system that employs symmetrical capacitive coupling. As illustrated in FIG. 9(b), a power transmission unit (power transmission device) 1 side is provided with a pair of active electrodes 4 and a power supply circuit (power supply) 100, and a power reception unit (power reception device) 2 side is provided with a pair of active electrodes 6 and a load circuit 24. In this case, strong electric fields 7 are also formed between the active electrodes 4 on the power transmission unit 1 side and the active electrodes 6 on the power receiving unit 2 side, whereby power is transmitted.
Patent Document 1: Japanese Unexamined Patent Application Publication No. 2009-296857

In the power transmission system of the related art, a signal source is formed that generates an alternating current by changing the power supply impedance to switch a direct current power supply from a constant voltage power supply to a constant current power supply and supplying a constant current to a direct current alternating current conversion element, and frequency sweeping is performed. Through the frequency sweeping, the frequency characteristics of the direct current voltage supplied to the direct-current alternating-current conversion element are measured and the frequency at which the impedance on the power reception device side 2 seen from the signal source is maximum is set to be the driving frequency to be used at the time of power transmission.

FIG. 10 is an equivalent circuit diagram of the power transmission system of the related art. Usually, the impedance on the power reception device 2 side seen from the signal source cannot be directly measured. Accordingly, as illustrated in FIG. 10, the impedance on the power reception device 2 side seen from the signal source is indirectly measured by detecting an input voltage Vᵢ input to an inverter circuit section of the power transmission device 1.

However, in a case where the resonant frequency is comparatively high and the frequency is swept in a range that does not include a frequency at which the impedance is minimum but includes a frequency at which the impedance is maximum, the following problems occur. FIG. 11 is an equivalent circuit diagram for a case where a power transmission device of the related art is regarded as a variable impedance element. The voltage at a point A in FIG. 11 can be obtained from Vᵢ×R4/(R1+R4) and therefore in the case where R4 is much larger than R1, the voltage at the point A is always close to the input voltage Vᵢ. In the case where the frequency is swept in a range that includes a frequency at which the impedance is maximum, the voltage at the point A is always shifted to be close to Vᵢ and therefore the point of maximum impedance cannot be detected correctly. Therefore, there has been a problem in that there has been a risk that the frequency at the time of power transmission may not be able to be correctly set.

### SUMMARY OF THE INVENTION

The present invention was made in light of the above-described circumstances and it is an object of the present invention to provide a power transmission system that can correctly detect the point of maximum impedance, even in the case where the resonant frequency is comparatively high and the frequency is swept in a range that includes a frequency at which the impedance is maximum.

In order to achieve the above-described object, a power transmission system according to the present invention includes a power transmission device including at least a pair of first electrodes and signal source that applies an alternating current signal to the first electrodes, and a power reception device that includes at least a pair of second electrodes that are arranged so as to respectively oppose the first electrodes and that are capacitively coupled with the first electrodes, and a load circuit to which received power is supplied. A first resonant circuit that includes a coupling capacitance between the first electrodes and the second electrodes is formed in the power transmission device, and a second resonant circuit that includes the coupling capacitance between the first electrodes and the second electrodes is formed in the power reception device. Power is transmitted from the power transmission device to the power reception device at a driving frequency determined by sweeping the frequency of the alternating current signal. The frequency is swept in a preset range including a minimum frequency at which an impedance including the first resonant circuit and the second resonant circuit seen from the power transmission device side is minimum and a maximum frequency at which the impedance is maximum until reaching the maximum frequency after passing at least the minimum frequency. The driving frequency is set to the frequency at which the impedance is maximum measured in the sweeping of the frequency.

With this configuration, power is transmitted by setting the driving frequency to a frequency at which the impedance including the first resonant circuit and the second resonant circuit seen from the power transmission device side is maximum. The frequency at which frequency sweeping is started is set such that a minimum frequency at which the impedance on the power reception device side seen from the signal source is minimum is located between the frequency at which frequency sweeping is to be started and the driving frequency. Thus, after lowering the voltage on the power transmission device side, which indirectly indicates the impedance on the power reception device side, so as to be in the vicinity of 0 V, the frequency at which the impedance on the power reception device side is maximum can be detected with certainty and a driving frequency at which the efficiency of power transmission is high can be easily set.

In addition, in the power transmission system according to the present invention, the frequency is swept in a step-like manner with steps of a predetermined frequency width, and a frequency width of steps used around a maximum frequency at which the impedance is maximum and a frequency width of steps used around a minimum frequency at which the impedance is minimum are preferably smaller than the frequency width of other steps in the range.

With the above-described configuration, the frequency width of steps used around a maximum frequency at which the impedance is maximum and the frequency width of steps used around a minimum frequency at which the impedance is minimum are smaller than the frequency width of other steps in the range in which the frequency is swept, and therefore the voltage on the power transmission device side, which indirectly indicates the impedance on the power reception device side, is lowered to be in the vicinity of 0 V and the time taken until detection can be made to fall within a fixed time range while the frequency at which the impedance is maximum is detected with certainty.

In addition, in the power transmission system according to the present invention, the frequency width of steps used around a maximum frequency is preferably smaller than the frequency width of steps used around a minimum frequency.

With the above-described configuration, since the frequency width of steps used around a maximum frequency is smaller than the frequency width of steps used around a minimum frequency, the voltage on the power transmission device side, which indirectly indicates the impedance on the power reception device side, is lowered until it is in the vicinity of 0 V, and the accuracy with which the frequency at which the impedance is maximum is detected is increased and yet the time taken until it is detected can be made to fall within a fixed time range.

In addition, in the power transmission system according to the present invention, the frequency is preferably swept from a low frequency side toward a high frequency side.

With the above-described configuration, the frequency is swept from the low frequency side toward the high frequency side and therefore, even in the case where a maximum frequency at which the impedance is maximum is shifted toward the high frequency side due to the coupling capacitance formed between the power reception device and the power transmission device changing whenever the power reception device is mounted, the maximum frequency can be serially detected from a minimum frequency that is shifted by a relatively small amount and the maximum frequency can be more accurately detected.

In addition, in the power transmission system of the present invention, one of the pair of first electrodes is a first active electrode and the other of the pair of first electrodes is a first passive electrode that is at a lower voltage than the first active electrode, and one of the pair of second electrodes is a second active electrode and the other of the pair of second electrodes is a second passive electrode that is at a lower voltage than the second active electrode.

With the above-described configuration, a high voltage is applied to the first active electrode and a high voltage is induced in the second active electrode by capacitive coupling and therefore the efficiency with which power is transmitted can be made high.

In addition, in the power transmission system according to the present invention, the second resonant circuit is preferably a parallel resonant circuit.

With this configuration, the frequency at which the impedance on the power reception device side is maximum can be detected with certainty and a driving frequency at which the efficiency of power transmission is high can be easily set.

In addition, in the power transmission system according to the present invention, the power transmission device includes a step-up transformer between the signal source and the first electrodes, and the power reception device includes a step-down transformer between the load circuit and the second electrodes.

With the above-described configuration, the power transmission device has a step-up transformer between the signal source and the first electrodes and the power reception device has a step-down transformer between the load circuit and the second electrodes, and therefore the voltage generated between the first active electrode and the first passive electrode can be made high and power is transmitted using a high voltage generated between the second active electrode and the second passive electrode via capacitive coupling and the efficiency with which power is transmitted can be made high.

In the power transmission system according to the invention, power is transmitted by setting the driving frequency to a frequency at which the impedance including the first resonant circuit and the second resonant circuit seen from the power transmission device side is maximum. The frequency at which frequency sweeping is started is set such that a minimum frequency at which the impedance on the power reception device side seen from the signal source is minimum is located between the frequency at which frequency sweeping is to be started and the driving frequency. Thus, after lowering the voltage on the power transmission device side, which indirectly indicates the impedance on the power reception device side, so as to be in the vicinity of 0 V, the frequency at which the impedance on the power reception device side is maximum can be detected with certainty and a driving frequency at which the efficiency of power transmission is high can be easily set.

### BRIEF DESCRIPTION OF THE DRAWINGS

FIG. 1 is a block diagram schematically illustrating a configuration of a power transmission system according to an embodiment of the present invention.

FIG. 2 is an equivalent circuit diagram of the power transmission system according to the embodiment of the present invention.

FIG. 3 is a graph illustrating the impedance characteristics on a power reception device side seen from the connection point between a signal source and a step-up/resonant circuit of the power transmission system according to the embodiment of the present invention.

FIG. 4 is a graph illustrating the change in direct current voltage on the power transmission device side in the case where the frequency is swept in a range of 550 kHz to 700 kHz before and after a frequency of 640 kHz at which the impedance is maximum in a power transmission system of the related art.

FIG. 5 is a graph illustrating the impedance characteristics on the power reception device side of the power transmission system according to the embodiment of the present invention.

FIG. 6 is a graph illustrating the change in direct current voltage on the power transmission device side in the case where the frequency is swept in a direction toward higher frequencies from in the vicinity of a frequency of 400 kHz at which a minimum point appears on the lower frequency side adjacent to a maximum point.

FIG. 7 is a flowchart illustrating the order of frequency sweeping processing performed by a control unit of the power transmission device of the power transmission system according to the embodiment of the present invention.

FIG. 8 is a graph illustrating the impedance characteristics on the power reception device side of the power transmission system according to the embodiment of the present invention.

FIGS. 9(a) and 9(b) are schematic diagrams that illustrate the configuration of a power transmission system of the related art.

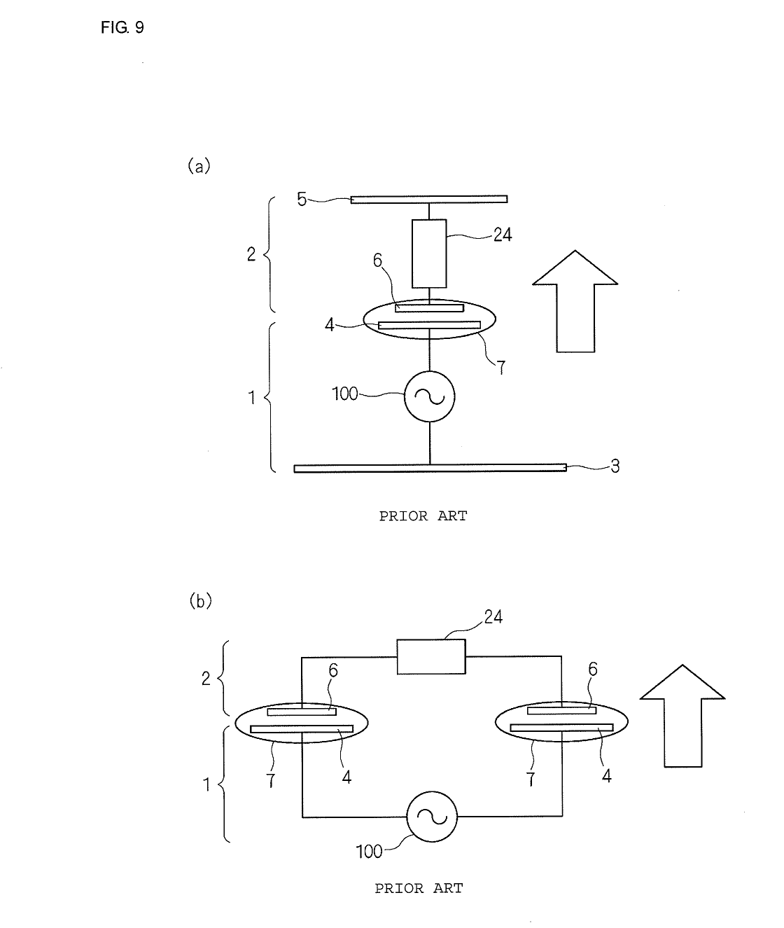

FIG. 10 is an equivalent circuit diagram of the power transmission system of the related art.

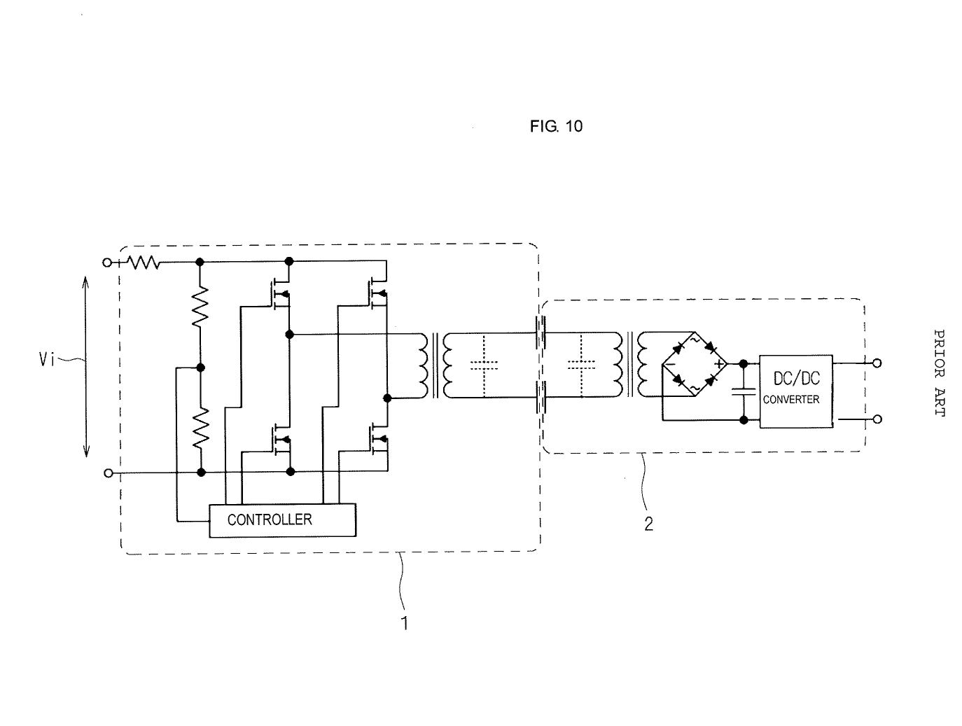

FIG. 11 is an equivalent circuit diagram for a case in which the power transmission device of the related art is regarded as a variable impedance element.

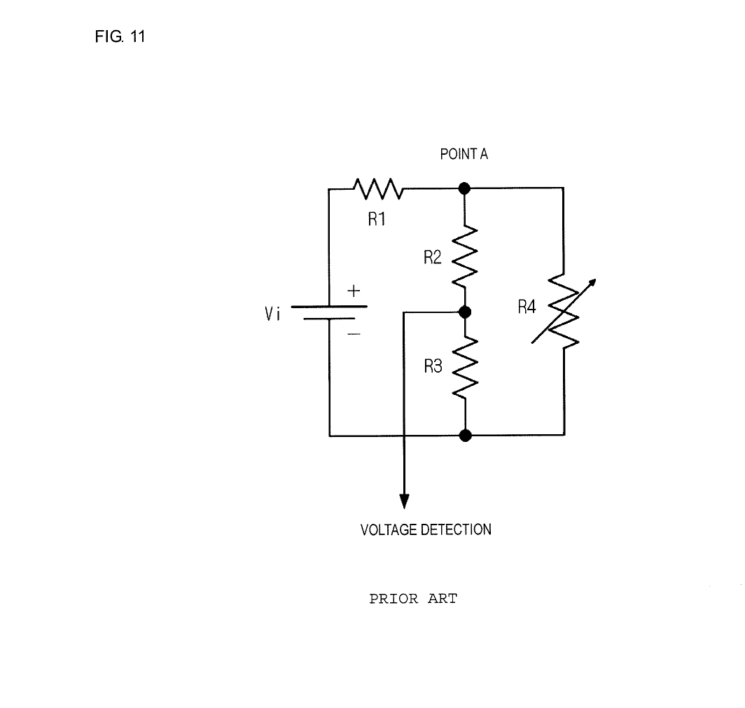

### DETAILED DESCRIPTION OF THE PREFERRED EMBODIMENTS OF THE INVENTION

Hereafter, a power transmission system according to an embodiment of the present invention will be concretely described using the drawings. It goes without saying that the following embodiment does not limit the invention described in the claims and all of the combinations of characteristic matters described in the embodiment are not necessarily required as means for solving the problem.

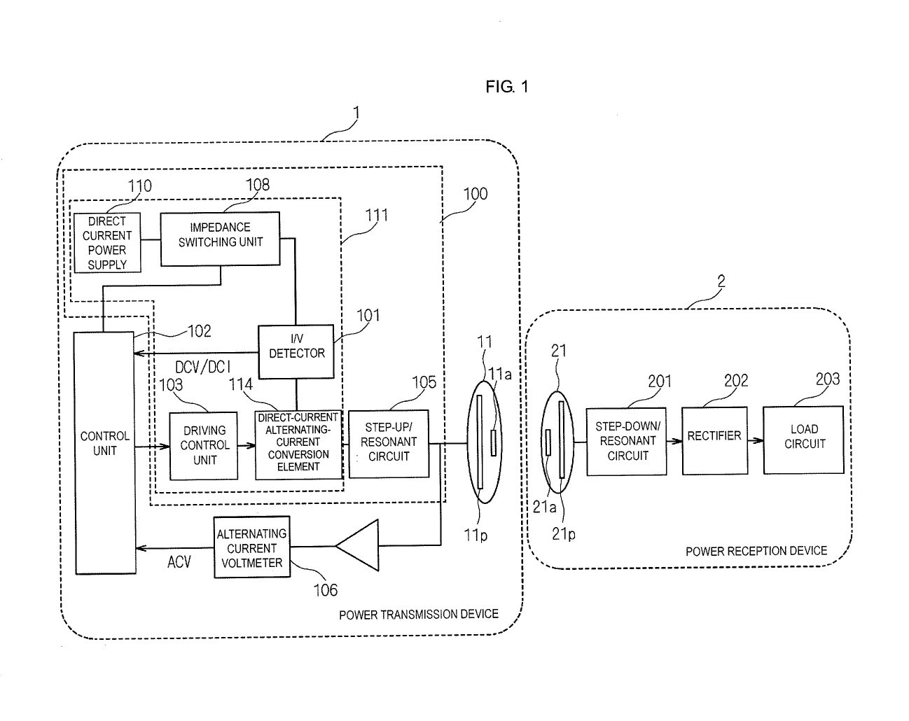

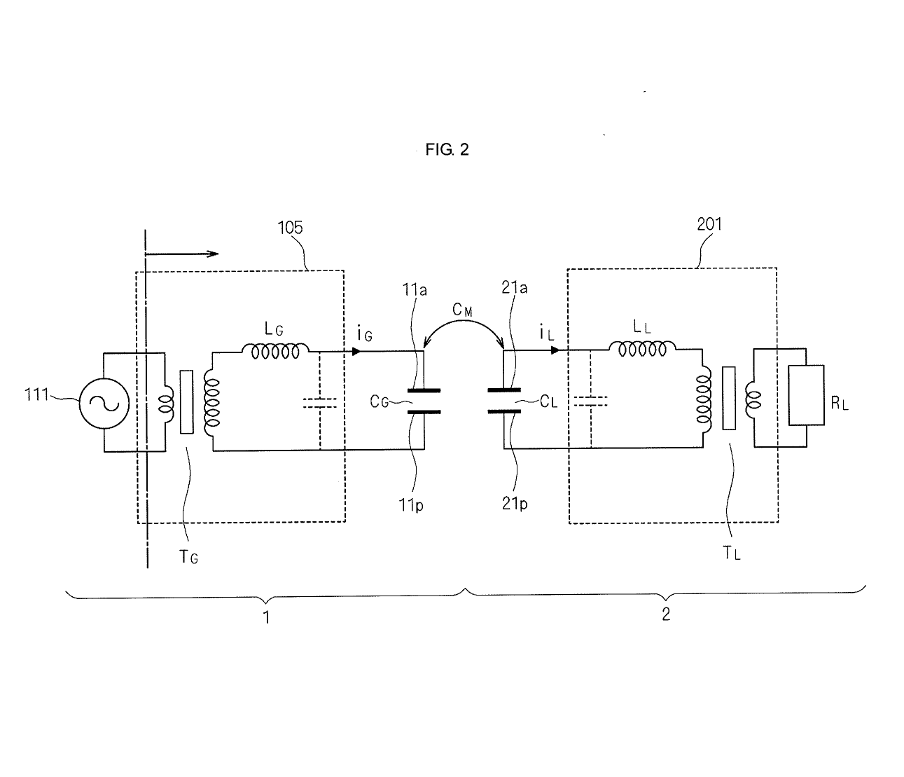

FIG. 1 is a block diagram schematically illustrating a configuration of a power transmission system according to an embodiment of the present invention. FIG. 2 is an equivalent circuit diagram of the power transmission system according to the embodiment of the present invention. In FIG. 1 and FIG. 2, a first active electrode 11a is connected to an active terminal, which is at a comparatively high potential, of a power supply 100 and a first passive electrode 11p is connected to a passive terminal, which is at a comparatively low potential, of the power supply 100. The first active electrode 11a and the first passive electrode 11p form a pair of power transmission electrodes (first electrodes) 11. As illustrated in FIG. 1 and FIG. 2, the power supply 100 is a high-voltage high-frequency power supply (alternating current power supply) and is formed of a low-voltage high-frequency power supply (signal source) 111 and a step-up/resonant circuit 105 that steps up the output voltage of the low-voltage high-frequency power supply 111.

The low-voltage high-frequency power supply (signal source) 111 is formed of a direct current power supply 110, an impedance switching unit 108 and a direct-current alternating-current conversion element 114. The direct current power supply 110 for example supplies a predetermined direct current voltage (for example, DC 5 V). A driving control unit 103 and the direct-current alternating-current conversion element 114 generate a voltage with a high frequency of for example 100 kHz to several MHz with the direct current power supply 110 serving as a power source. The step-up/resonant circuit 105 is formed of a step-up transformer TG and an inductor LG and steps up a high-frequency voltage and supplies the stepped-up high-frequency voltage to the first active electrode 11a. A capacitance CG represents a coupling capacitance between the first passive electrode 11p and the first active electrode 11a. A series resonant circuit (first resonant circuit) is formed by the inductor LG and the capacitance CG. An I/V detector 101 detects a direct current voltage DCV and a direct current current DCI supplied from the direct current power supply 110 and passes the detected voltage and current to a control unit 102. The control unit (control circuit unit) 102 controls operation of the driving control unit 103 on the basis of the outputs of the I/V detector 101 and an alternating current voltmeter 106, which will be described later.

The control unit 102 obtains a direct current voltage DCV detected by the I/V detector 101 and analyzes the frequency characteristics of the obtained direct current voltage DCV and detects whether a power reception device 2 is mounted. Specifically, until the power reception device 2 is mounted and transmission of power starts, the power supply 100 operates as a constant current power supply as a result of switching to a constant current being performed by the impedance switching unit 108, which switches the output impedance of the direct current power supply 110, and performs frequency sweeping using a comparatively low voltage.

When frequency sweeping is performed, a maximum point does not arise in the direct current voltage DCV in a state in which the power reception device 2 is not mounted. That is, there is no frequency at which the size of a change in the direct current voltage DCV per unit frequency is larger than a predetermined value.

In contrast, in the case where the power reception device 2 is mounted, the impedance on the power reception device 2 side seen from a power transmission device 1 side becomes maximum due to the impedance of a second resonant circuit formed in the mounted power reception device 2 and a maximum point is generated in the direct current voltage DCV in the vicinity of the frequency at which the impedance becomes maximum. That is, since there is a frequency at which the size of the change in the direct current voltage DCV per unit frequency is larger than the predetermined value, mounting of the power reception device 2 can be detected when that frequency is detected. When it is detected that the power reception device 2 has been mounted, the power supply 100 is switched to constant voltage power supply by the impedance switching unit 108 and the frequency at which the detected impedance is maximum can be set as the driving frequency.

In the power transmission system according to this embodiment, power is transmitted at a frequency at which an impedance, seen from the signal source side, including the first resonant circuit, a coupling capacitance CM and the second resonant circuit to be described later is maximum. The frequency is swept with the low-voltage high-frequency power supply 111 serving as a constant current power supply and the frequency at which the impedance is maximum is detected on the basis of the change in the direct current voltage DCV on the power transmission device 1 side. Power transmission efficiency can be maximized by setting the driving frequency to the detected frequency.

The control unit 102 controls the driving control unit 103 and the driving control unit 103 subjects a direct current voltage to DC-AC conversion to an alternating current voltage having a predetermined frequency and a predetermined voltage by using the direct-current alternating-current conversion element 114. The direct-current alternating-current conversion element 114 supplies the alternating current voltage to the step-up/resonant circuit 105.

The step-up/resonant circuit 105 steps up the supplied alternating current voltage and supplies the stepped up alternating current voltage to the power transmission electrodes 11 (first active electrode 11a and first passive electrode 11p). The power transmission electrodes 11 of the power transmission device 1 are capacitively coupled with a pair of power reception electrodes (second electrodes) 21 (second active electrode 21a and second passive electrode 21p) of the power reception device 2 and thereby transmit power. A step-down/resonant circuit 201, which is formed of a step-down transformer TL and an inductor LL, is connected to the power reception electrodes 21 of the power reception device 2. A capacitance CL represents the capacitance between the second passive electrode 21p and the second active electrode 21a. In this embodiment, a series resonant circuit (second resonant circuit) is formed of the inductor LL and the capacitance CL included in the step-down/resonant circuit 201. This series resonant circuit has a characteristic resonant frequency. The capacitance CM represents the coupling capacitance between the power transmission electrodes 11 and the power reception electrodes 21. The coupling capacitance CM is also called a mutual capacitance.

In the power reception device 2, the transmitted power is stepped down by the step-down/resonant circuit 201, the stepped down voltage is rectified by a rectifier 202 and power is supplied to a load circuit 203 as a rectified voltage.

In the power transmission system according to this embodiment, power is transmitted at a frequency at which the impedance of the first resonant circuit and the second resonant circuit including the capacitance CM is maximum. This impedance means the impedance between the terminals of the primary winding of the step-up transformer TG, that is, the impedance including part of the power transmission device 1 connected to the signal source ill and the power reception device 2. Hereafter, for simplicity, this impedance will be referred to as the power reception device 2 side impedance.

Power transmission efficiency can be maximized by performing frequency sweeping and setting the driving frequency to the frequency at which the power reception device 2 side impedance seen from the connection point between the signal source 111 and the step-up/resonant circuit 105 is maximum. The frequency at which the power reception device 2 side impedance is maximum can be obtained from the frequency characteristics of the power reception device 2 side impedance.

In FIG. 2, the first passive electrode 11p and the second passive electrode 21p are not connected to the ground potential, but even in a case where the first passive electrode 11p is connected to the ground potential and the second passive electrode 21p is not connected to the ground potential, power can be transmitted in a non-contact manner from the power transmission device 1 to the power reception device 2. In addition, even in the case where the first passive electrode 11p is not connected to the ground potential and the second passive electrode 21p is connected to the ground potential, similarly, power can be transmitted in a non-contact manner.

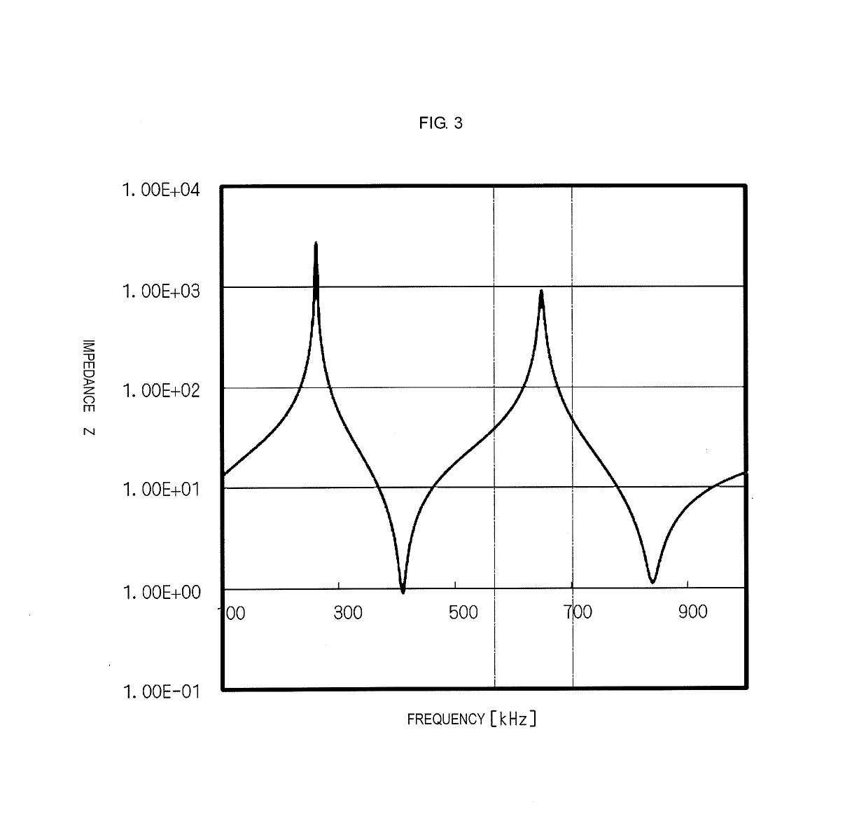

FIG. 3 is a graph illustrating the impedance characteristics on the power reception device 2 side seen from the connection point between the signal source 111 and the step-up/resonant circuit 105 of the power transmission system according to the embodiment of the present invention. In FIG. 3, the vertical axis represents impedance Z, the horizontal axis represents frequency (kHz) and it is clear that maximum and minimum points occur in the impedance Z. In order to achieve high power transmission efficiency, the driving frequency may be set to a frequency at which the impedance Z is maximum, that is, in FIG. 3, a frequency of around 640 kHz. Therefore, it has been thought that a point of maximum impedance Z can be detected if the frequency is swept in the range of 550 kHz to 700 kHz before and after the frequency of 640 kHz at which the impedance Z is maximum.

However, the impedance Z on the power reception device 2 side cannot be directly measured. Consequently, in reality, the maximum point is detected by measuring the impedance Z on the power reception device 2 side from the direct current voltage DCV detected by the I/V detector 101 of the power transmission device 1. That is, in the case where the frequency is swept in a range that includes a frequency at which the impedance Z is maximum in order to detect the point of maximum impedance Z, a state of high impedance is maintained and therefore the direct current voltage DCV detected by the I/V detector 101 is not reset. In addition, whenever the power reception device 2 is mounted on the power transmission device 1, the coupling capacitance CM changes and as a result the point of maximum impedance Z on the power reception device 2 side seen from the power transmission device 1 side is easily shifted toward the high frequency side. Therefore, in the case where the frequency at which a maximum point appears is a high frequency, there has been a risk that the maximum point has not been able to be correctly detected.

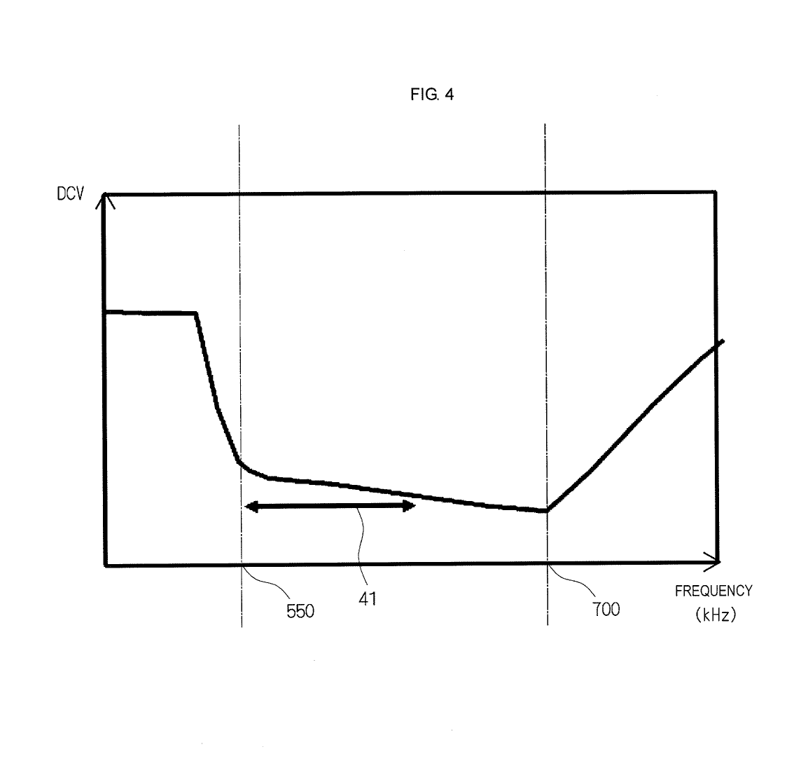

For example, FIG. 4 is a graph illustrating the change in direct current voltage DCV on the power transmission device 1 side in the case where the frequency is swept in a range of 550 kHz to 700 kHz before and after a frequency of 640 kHz at which the impedance Z is maximum in a power transmission system of the related art. In FIG. 4, the vertical axis represents the direct current voltage DCV and the horizontal axis represents the frequency (kHz) and a maximum point does not occur in a range 41 in which a maximum point is supposed to be detected.

Accordingly, in this embodiment, the frequency is not simply swept in a range before and after a frequency at which the impedance Z is maximum but is swept in a range including a frequency at which a minimum point appears that is adjacent to a maximum point and on the lower frequency side, starting from a frequency that is at least slightly lower than the frequency at which the minimum point appears in a direction toward higher frequencies. This is because it was discovered that, since a frequency at which the impedance Z is minimum is necessarily swept when performing frequency sweeping in this way, the direct current voltage DCV of the power transmission device 1 can be reset with certainty and the maximum point can be correctly detected even if the frequency at which the maximum point appears is a high frequency.

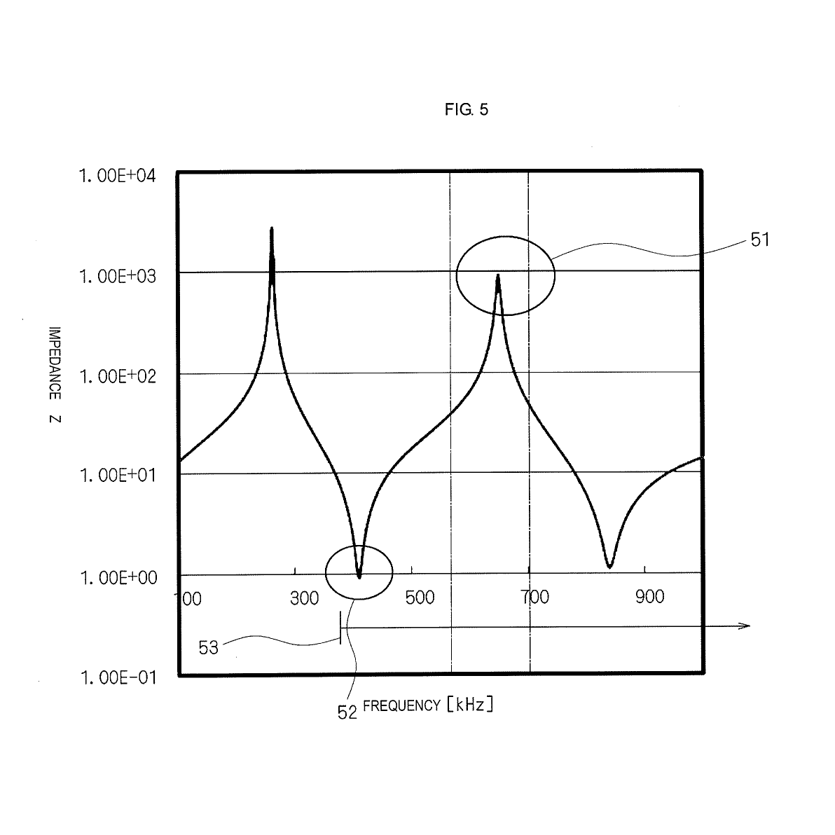

FIG. 5 is a graph illustrating impedance characteristics on the power reception device 2 side of the power transmission system according to the embodiment of the present invention. In FIG. 5, the vertical axis also represents impedance Z and the horizontal axis also represents frequency (kHz). As illustrated in FIG. 5, the frequency is swept in the direction of the arrow (direction toward higher frequencies) from in the vicinity of a frequency (minimum frequency) at which a minimum point 52 appears that is adjacent to a maximum point 51 of the impedance Z and on the lower frequency side, or from a frequency 53, which is slightly lower than the frequency at which the minimum point 52 appears.

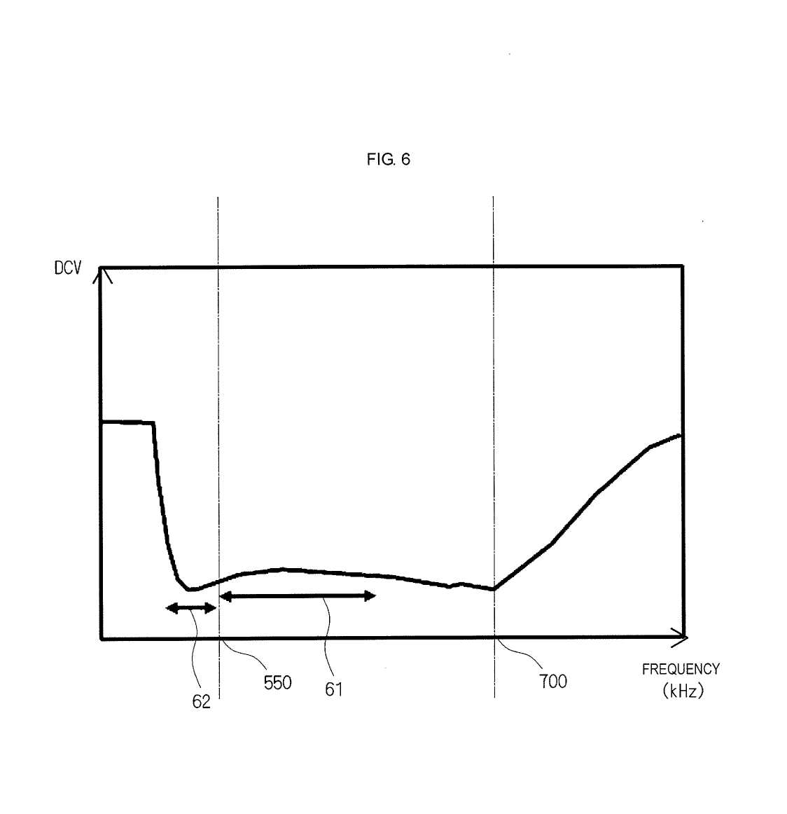

FIG. 6 is a graph illustrating the change in direct current voltage DCV on the power transmission device 1 side in the case where the frequency is swept in a direction toward higher frequencies from in the vicinity of a frequency of 400 kHz at which a minimum point appears that is adjacent to a maximum point and on the lower frequency side. In FIG. 6, the vertical axis also represents the direct current voltage DCV and the horizontal axis also represents frequency (kHz).

As illustrated in FIG. 6, the frequency is swept in a direction toward higher frequencies from in the vicinity of a minimum frequency of 400 kHz at which a minimum point appears that is adjacent to a maximum point of impedance Z and on the lower frequency side, whereby, together with the minimum point occurring in a range 62 in which a minimum point is supposed to be detected, a maximum point occurs in a range 61 in which a maximum point is supposed to be detected.

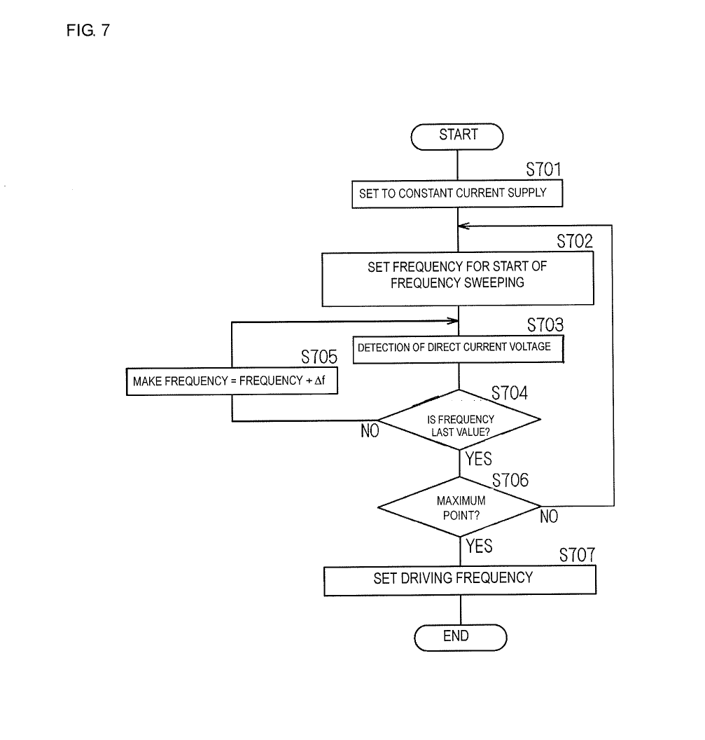

FIG. 7 is a flowchart illustrating the order of the frequency sweeping processing performed by the control unit 102 of the power transmission device 1 of the power transmission system according to the embodiment of the present invention. In FIG. 7, the control unit 102 of the power transmission device 1 performs setting so that a constant current is supplied to the direct-current alternating-current conversion element 114 due to switching to a constant current performed by the impedance switching unit 108 (step S701).

The control unit 102 sets the frequency at which frequency sweeping is to be started to a frequency equal to or less than a frequency at which it is supposed that the impedance is minimum (step S702) and drives the driving control unit 103 at that set frequency. That is, the frequency at which frequency sweeping is to be started is set such that a minimum frequency at which the impedance is a minimum on the power reception device 2 side is located between the frequency at which frequency sweeping is to be started and the driving frequency. Of course, the frequency may be set to a frequency at which it is supposed the impedance is minimum or may be set to be in the vicinity of such a frequency.

The control unit 102 detects the direct current voltage DCV with the I/V detector 101 (step S703) and determines whether the set frequency is the last value in the range of frequency sweeping (step S704). In the case where the control unit 102 determines that the set frequency is not the last value in the range of frequency sweeping (step S704: NO), the control unit 102 adds a fixed frequency Δf to the set frequency and sets the resulting frequency as the new frequency for the start of frequency sweeping (step S705), and returns the processing to step S703 and repeats the above-described processing.

In the case where the control unit 102 determines that the set frequency is the last value in the range of frequency sweeping (step S704: YES), the control unit 102 determines whether a maximum point has occurred in the direct current voltage DCV (step S706). In the case where the control unit 102 determines that a maximum point has not occurred (step S706: NO), the control unit 102 returns the processing to step S702, newly sets again the frequency for the start of frequency sweeping and repeats the above-described processing.

In the case where the control unit 102 determines that a maximum point has occurred (step S706: YES), the control unit 102 sets the driving frequency to the frequency at which the direct current voltage DCV is maximum (step S707) and performs setting such that a constant voltage is supplied to the direct-current alternating-current conversion element 114 as a result of the impedance switching unit 108 performing switching to a constant voltage, and transmission of power is started. That is, the driving frequency is set to the frequency at which the second resonant circuit 201, the second active electrode 21a and the second passive electrode 21p resonate and the impedance on the power reception device 2 side is maximum.

The direction in which the frequency is swept is not limited to a direction from the lower frequency side to the higher frequency side, and may be in the opposite direction from the higher frequency side to the lower frequency side, but sweeping from the lower frequency side to the higher frequency side is preferable since the frequency at which the impedance is maximum can be detected with certainty even in the case where the frequency at which the impedance Z is maximum is shifted toward the high-frequency side due to variation of the above-mentioned coupling capacitance CM.

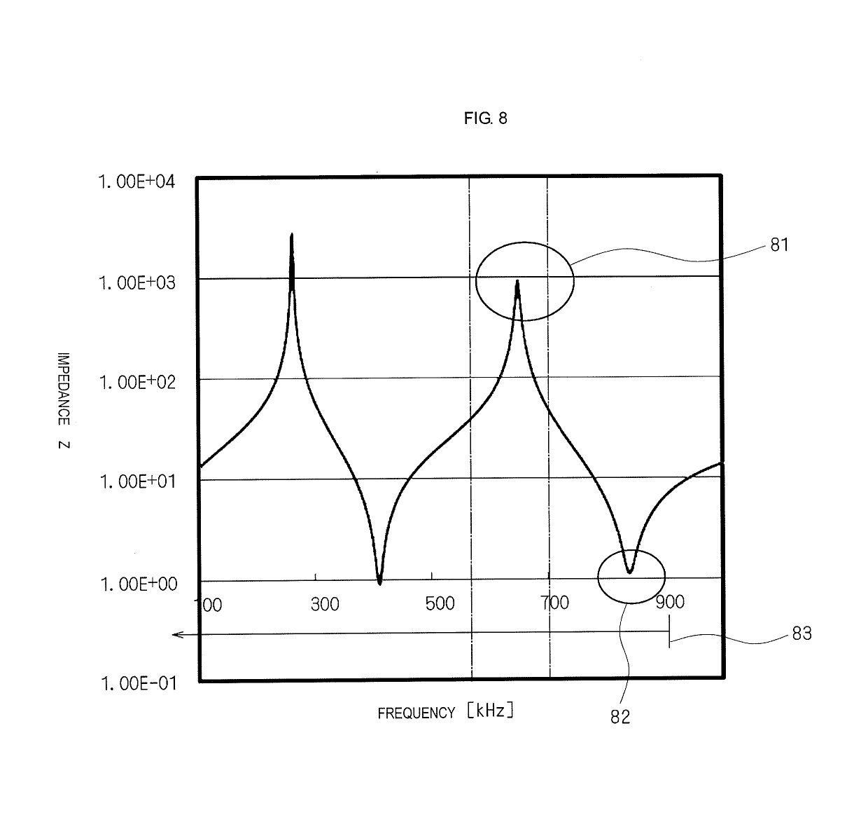

FIG. 8 is a graph illustrating impedance characteristics on the power reception device 2 side of the power transmission system according to the embodiment of the present invention. In FIG. 8, the vertical axis also represents impedance Z and the horizontal axis also represents frequency (kHz).

As illustrated in FIG. 8, the frequency is swept in a range including the frequency at which a minimum point 82 appears that is adjacent to a maximum point 81 of the impedance Z and on the higher frequency side in the direction of the arrow from for example a frequency 83 (direction toward lower frequencies). Even when the direction in which the frequency is swept is reversed in this way, similarly to as in FIG. 6, a maximum point occurs in the range in which maximum point is to be detected.

According to the above-described embodiment, the frequency is swept and power is transmitted at a frequency at which the efficiency of power transmission is maximum. The frequency at which frequency sweeping is started is set so that a minimum frequency at which the impedance is minimum on the power reception device side, that is, a minimum frequency at which direct current voltage on the power transmission device side is minimum is located between the frequency at which frequency sweeping is to be started and the driving frequency, whereby the frequency at which the impedance including the first resonant circuit and the second resonant circuit is maximum can be detected with certainty and a driving frequency at which efficiency of power transmission is high can be easily set.

In addition, in the case where the driving frequency has been increased, the range over which the frequency is swept is very wide. When the range over which the frequency is swept is wide, time required to sweep the frequency is also long. However, in the case where the frequency is swept in a step-like manner in steps of a predetermined width (for example, steps of 1 kHz or 10 kHz), a frequency width of steps used around a minimum frequency at which the impedance Z is minimum and a frequency width of steps used around a maximum frequency at which the impedance Z is maximum are made smaller than the frequency width of other steps in the range in which the frequency is swept, in other words, the frequency width of steps used in sweeping outside the vicinities of the minimum frequency and the maximum frequency is made larger, whereby on the whole the time taken until a maximum frequency is detected can be shortened and the time taken until detection can be made to fall within a fixed time range while the frequency at which the impedance Z is maximum can be detected with certainty. It is important that a maximum frequency at which the impedance Z is maximum be detected correctly and therefore it is preferable that a frequency width of steps used around a maximum frequency at which the impedance Z is maximum be made smaller than a frequency width of steps used around a minimum frequency at which the impedance Z is minimum.

In this embodiment, it was described that one electrode in at least one pair of first electrodes 11 is made to serve as a first active electrode 11a and the other electrode is made to serve as a first passive electrode 11p, which is at a lower voltage than the first active electrode 11a, and similarly one electrode in a pair of second electrodes 21 is made to serve as a second active electrode 21a and the other electrode is made to serve as a second passive electrode 21p, which is at a lower voltage than the second active electrode 21a, that is, a so-called asymmetrical configuration was described. Of course, the configuration is not limited to the asymmetrical configuration and even if signals having the same amplitude and that are 180° out of phase are applied to the pair of first electrodes 11, that is, a so-called symmetrical configuration is adopted, similarly to as in this embodiment, the frequency at which the impedance is maximum can be detected with certainty and a driving frequency at which the efficiency of power transmission is high can be easily set.

In addition, in this embodiment, description was given of a configuration in which the power transmission device 1 is equipped with the step-up transformer TG and a first resonant circuit, but a configuration that does not include the step-up transformer TG may instead be adopted. In this case, in FIG. 2, the invention according to this embodiment may be applied to the impedance on the power reception device 2 side seen from the connection point at which the signal source 111 is directly connected to the inductor LG.

In other respects, it goes without saying that the present invention is not limited to the above-described embodiment and various modifications and substitutions are possible within the scope of the gist of the present invention.

### REFERENCE SIGNS LIST

1 power transmission device
2 power reception device
11 power transmission electrodes (first electrodes)
11a first active electrode
11p first passive electrode
21 passive electrodes (second electrodes)
21a second active electrode
21p second passive electrode
100 power supply
102 control unit
105 step-up/resonant circuit
108 impedance switching unit
111 low voltage high frequency power supply (signal source)
114 direct current alternating current conversion element
201 step-down/resonant circuit
203 load circuit

1. A power transmission system comprising:
a power transmission device including at least a pair of first electrodes, a power supply configured to supply an alternating current signal to the pair of first electrodes, and a control unit coupled to the power supply; and
a power reception device including at least a pair of second electrodes arranged to oppose the pair of first electrodes, respectively, when the power reception device is mounted to the power transmission device, and a load circuit configured to receive power from the power transmission device,
wherein, when the power reception device is mounted to the power transmission device, a first resonant circuit is formed in the power transmission device that includes a coupling capacitance between the first electrodes and the second electrodes, and a second resonant circuit is formed in the power reception device that includes the coupling capacitance between the first electrodes and the second electrodes, and
wherein the control unit is configured to control the power supply to sweep the alternating current signal at a preset frequency range to determine a driving frequency at which an impedance of the first resonant circuit and the second resonant circuit detected by the power transmission device is a maximum value, and
wherein the power supply is further configured to supply the power at the driving frequency.

2. The power transmission system according to claim 1, wherein the preset frequency range includes a minimum frequency at which the impedance is a minimum value and a maximum frequency at which the impedance is the maximum value.

3. The power transmission system according to claim 2, wherein the control unit is configured to control the power supply to sweep the alternating current signal in a step-like manner with steps having a predetermined frequency width.

4. The power transmission system according to claim 3, wherein a frequency width of the steps around the maximum frequency and the minimum frequency are smaller than a frequency width of the steps in the preset frequency range.

5. The power transmission system according to claim 4, wherein the frequency width of the steps around the maximum frequency are smaller than the frequency width of the steps around the minimum frequency.

6. The power transmission system according to claim 1, wherein the control unit is configured to control the power supply to sweep the alternating current signal from a low frequency to a high frequency.

7. The power transmission system according to claim 1, wherein one of the pair of first electrodes is a first active electrode and the other of the pair of first electrodes is a first passive electrode having a lower voltage than the first active electrode.

8. The power transmission system according to claim 7, wherein one of the pair of second electrodes is a second active electrode and the other of the pair of second electrodes is a second passive electrode having a lower voltage than the second active electrode.

9. The power transmission system according to claim 1, wherein the second resonant circuit is a parallel resonant circuit.

10. The power transmission system according to claim 1, wherein the power supply comprises a low-voltage high-frequency power supply coupled to the control unit and a step-up transformer disposed between the low-voltage high-frequency power supply and the pair of first electrodes.

11. The power transmission system according to claim 10, wherein the low-voltage high-frequency power supply comprises a current/voltage detector communicatively coupled to the control unit and configured to provide a direct current voltage to the control unit.

12. The power transmission system according to claim 11, wherein the control is further configured to detect whether the power reception device is mounted to the power transmission device based on the direct current voltage received from the current/voltage detector.

13. The power transmission system according to claim 12, wherein the low-voltage high-frequency power supply further comprises a direct current supply communicatively coupled to the current/voltage detector and configured to provide a direct current signal source.

14. The power transmission system according to claim 13, wherein the control unit is configured to determine the maximum value of the impedance of the first resonant circuit and the second resonant circuit based on a maximum point of the direct current voltage received from the current/voltage detector.

15. The power transmission system according to claim 13, wherein the low-voltage high-frequency power supply further comprises a impedance switching unit coupled between the direct current supply and the current/voltage detector, the impedance switching unit being configured to switch the power supply to a constant voltage power supply at the driving frequency after the power reception device has been mounted to the power transmission device.

16. The power transmission system according to claim 11, wherein the low-voltage high-frequency power supply further comprises a direct-to-alternating current conversion element configured to supply the alternating current signal to the pair of first electrodes.

17. The power transmission system according to claim 1, wherein a minimum frequency of the preset frequency range is equal to or less than a predetermined frequency at which the control unit supposes the impedance is a minimum value.

18. The power transmission system according to claim 17, wherein the control unit is configured to control the power supply to sweep the alternating current signal by repeatedly increasing the minimum frequency by a fixed frequency until the driving frequency is determined. (support in ¶ [0063])

19. The power transmission system according to claim 1, wherein the power reception device includes a step-down transformer disposed between the load circuit and the pair of second electrodes.

20. The power transmission system according to claim 19, wherein the power reception device further includes a rectifier configured to rectify a stepped-down voltage provided by the step-down transformer.
